(19) United States
(12) Patent Application Publication
(10) Pub. No.: US 2022/0270216 A1
(43) Pub. Date: Aug. 25, 2022

(54) Videoconferencing with Adaptive Lens Distortion-Correction and Image Deformation-Reduction

(71) Applicant: Plantronics, Inc., Santa Cruz, CA (US)

(72) Inventors: TIANRAN WANG, BEIJING (CN); HAI XU, BEIJING (CN); XINGYUE HUANG, BEIJING (CN); HAILIN HAILIN SONG, BEIJING (CN)

(73) Assignee: Plantronics, Inc., Santa Cruz, CA (US)

(21) Appl. No.: 17/632,226

(22) PCT Filed: Jul. 30, 2020
(86) PCT No.: PCT/US2020/044288

§ 371 Date: Feb. 1, 2022

(30) Foreign Application Priority Data
Aug. 1, 2019 (CN) 201910706478.9

(51) Int. Cl. G06T 5/00; G06T 7/60

(52) U.S. Cl. CPC G06T 5/006; G06T 7/60; G06T 2207/10016; G06T 2207/30201

(57) ABSTRACT

A videoconferencing endpoint can adaptively adjust for lens distortion and image deformation depending on the distance of the subject from a camera and the radial distance of the subject from the center of the camera's field of view.

### TECHNICAL FIELD

This disclosure relates generally to videoconferencing and relates particularly to a hybrid approach to correcting for deformation in facial imaging.

### BACKGROUND

Attempts to correct for both image distortion and image deformation for images captured by wide-angle lenses have not been wholly satisfactory. Thus, there is room for improvement in the art.

### BRIEF DESCRIPTION OF THE DRAWINGS

For illustration, there are shown in the drawings certain examples described in the present disclosure. In the drawings, like numerals indicate like elements throughout. The full scope of the inventions disclosed herein are not limited to the precise arrangements, dimensions, and instruments shown. In the drawings:

FIG. 1 illustrates a videoconferencing endpoint, in accordance with an example of this disclosure;

FIG. 2 illustrates aspects of the videoconferencing endpoint of FIG. 1, in accordance with an example of this disclosure;

FIG. 3 illustrates an image which has been corrected for distortion, in accordance with an example of this disclosure;

FIG. 4 illustrates a raw room view image and a room view image in which distortion in the raw room view has been reduced, in accordance with an example of this disclosure;

FIG. 5 illustrates speaker views before and after distortion-correction, in accordance with an example of this disclosure;

FIG. 6 illustrates magnification of subjects sitting at different locations, in accordance with an example of this disclosure;

FIG. 7 illustrates a processor receiving frames of facial data captured by a camera, in accordance with an example of this disclosure;

FIG. 8 illustrates a method of adaptively correcting for facial image deformation, in accordance with an example of this disclosure;

FIG. 9 illustrates a map of an advanced lens distortion-correction method with deformation-reduction, in accordance with an example of this disclosure;

FIG. 10 illustrates a plurality of focus-view images, in accordance with an example of this disclosure;

FIG. 11 illustrates a field of view for a wide-angle camera and a chart of tables for corresponding to subdivisions thereof, in accordance with an example of this disclosure;

FIG. 12 illustrates a videoconferencing device, in accordance with an example of this disclosure; and

FIG. 13 illustrates a method of reducing deviations in images captured by a wide-view camera, in accordance with an example of this disclosure.

### DETAILED DESCRIPTION

In the drawings and the description of the drawings herein, certain terminology is used for convenience only and is not to be taken as limiting the examples of the present disclosure. In the drawings and the description below, like numerals indicate like elements throughout.

Introduction

Images captured using a wide-angle lens inherently include distortion (405) effects and deformation effects. As used herein, distortion (405) refers to bending of light such that straight lines appear curved in an image. As used herein, deformation refers to “stretching” in a portion of an image such that objects appear larger in one or more dimensions than is natural. As used herein, the term deviation encompasses both distortion (405) and deformation. Distortion (405) and/or deformation may be corrected in an image by applying a transformation to the image. However, distortion-correction (508) can exacerbate deformation. Distortion (405) and deformation may be relatively more noticeable in different portions of an image. For example, in a cropped view of an image, deformation may be more noticeable than in a full view of the image. Further, deformation may be more noticeable at edges of the image (403) as compared to areas closer to the center (304). Disclosed are systems and methods (800) for selectively correcting distortion (405) and deformation in images. While the disclosed systems and methods (800) are described in connection with a teleconference system, it should be noted that the disclosed systems and methods (800) can used in other contexts according to the disclosure.

Discussion

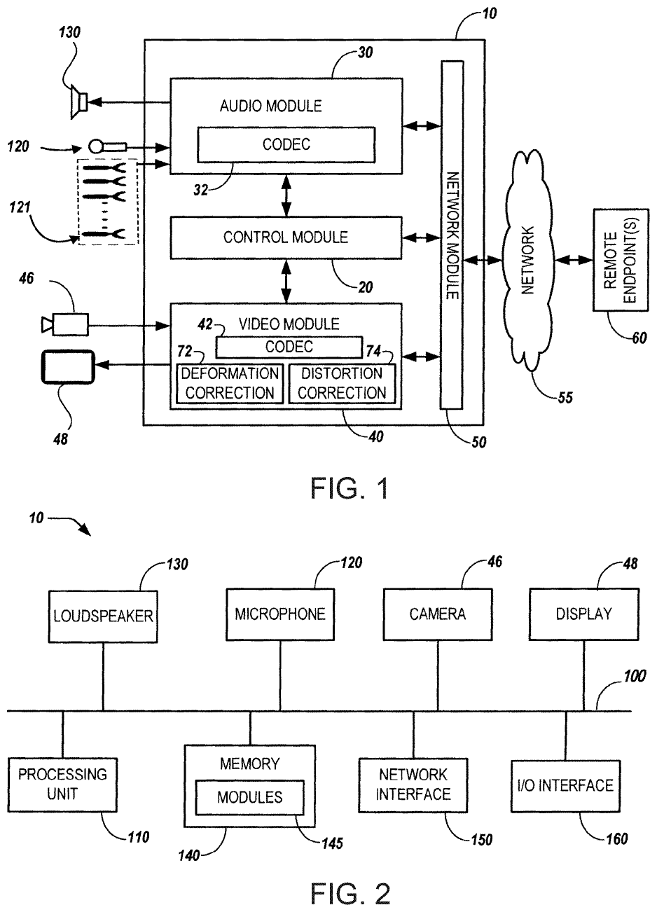

FIG. 1 illustrates a conferencing apparatus or videoconferencing endpoint 10 in accordance with an example of this disclosure. The conferencing apparatus or videoconferencing endpoint 10 of FIG. 1 communicates with one or more remote videoconferencing endpoints 60 over a network 55. The videoconferencing endpoint 10 includes an audio module 30 with an audio codec 32, and a video module 40 with a video codec 42. These modules 30/40 operatively couple to a control module 20 and a network module 50. The modules 30/40/20/50 include dedicated hardware, software executed by one or more processors (1220), or a combination thereof. In some examples, the video module 40 corresponds to a graphics processing unit (GPU), software executable by the graphics processing unit, a central processing unit (CPU), software executable by the CPU, or a combination thereof. In some examples, the control module 20 includes a CPU, software executable by the CPU, or a combination thereof. In some examples, the network module 50 includes one or more network interface devices, a CPU, software executable by the CPU, or a combination thereof. In some examples, the audio module 30 includes, a CPU, software executable by the CPU, a sound card, or a combination thereof.

In general, the videoconferencing endpoint 10 can be a conferencing device, a videoconferencing device, a personal computer with audio or video conferencing abilities, or any similar type of communication device. The videoconferencing endpoint 10 is configured to generate near-end audio and video and to receive far-end audio and video from the remote videoconferencing endpoints 60. The videoconferencing endpoint 10 is configured to transmit the near-end audio and video to the remote videoconferencing endpoints 60 and to initiate local presentation of the far-end audio and video.

A microphone 120 captures audio and provides the audio to the audio module 30 and codec 32 for processing. The microphone 120 can be a table or ceiling microphone, a part of a microphone pod, an integral microphone to the videoconferencing endpoint 10, or the like. Additional microphones 121 can also be provided. Throughout this disclosure all descriptions relating to the microphone 120 apply to any additional microphones 121, unless otherwise indicated. The videoconferencing endpoint 10 uses the audio captured with the microphone 120 primarily for the near-end audio. A camera 46 captures video and provides the captured video to the video module 40 and codec 42 for processing to generate the near-end video. For each frame (705) of near-end video captured by the camera 46, the control module 20 selects a view region, and the control module 20 or the video module 40 crops the frame (705) to the view region. The view region may be selected based on the near-end audio generated by the microphone 120 and the additional microphones 121, other sensor data, or a combination thereof. For example, the control module 20 may select an area of the frame (705) depicting a participant who is currently speaking as the view region. As another example, the control module 20 may select the entire frame (705) as the view region in response to determining that no one has spoken for a period of time. Thus, the control module 20 selects view regions based on a context of a communication session.

The camera 46 includes a wide-angle lens. Due to the nature of wide-angle lenses, video (and still images) captured by the camera 46 includes both distortion (405) and deformation (507) effects. The video module 40 includes deformation-reduction (1050) logic 72 and distortion-correction (508) logic 74. In some examples, the deformation-reduction (1050) logic 72 and the distortion-correction (508) logic 74 correspond to mapping tables (e.g., 807, 809, 811) that identify adjustments to make to images captured by the camera 46. In at least one example of this disclosure, the mapping tables are based on properties of a lens of the camera 46, such as focal length, etc. For each frame (705) of video captured by the camera 46, the video module 40 selects the deformation-reduction (1050) logic 72 or the distortion-correction (508) logic 40 based on a size of a view region selected by the control module 20 for that frame (705) as described further below herein. The video module 40 then applies the selected correction logic to the view region of the frame (705) to generate a corrected near end video frame (705). Thus, each corrected near-end video frame (705) corresponds to a potentially cropped and corrected version of a video frame (705). The corrected near end video frames (705) taken together comprise corrected near-end video.

The videoconferencing endpoint 10 uses the codecs 32/42 to encode the near-end audio and the corrected near-end video according to any of the common encoding standards, such as MPEG-1, MPEG-2, MPEG-4, H.261, H.263 and H.264. Then, the network module 50 outputs the encoded near-end audio and corrected video to the remote videoconferencing endpoints 60 via the network 55 using any appropriate protocol. Similarly, the network module 50 receives the far-end audio and video via the network 55 from the remote videoconferencing endpoints 60 and sends these to their respective codec 32/42 for processing. Eventually, a loudspeaker 130 outputs the far-end audio (received from a remote videoconferencing endpoint), and a display 48 outputs the far-end video. The display 48 also outputs the corrected near-end video in some examples.

FIG. 1 thus illustrates an example of a device that selectively corrects deformation (507) or distortion (405) in video captured by a camera 46 with a wide-angle lens. In particular, the device of FIG. 1 may operate according to one of the methods (800) described herein. As described below, these methods (800) may improve video quality during a communication session.

FIG. 2 illustrates components of the conferencing videoconferencing endpoint 10 of FIG. 1 in detail. The videoconferencing endpoint 10 has a processing unit 110, memory 140, a network interface 150, and a general input/output (I/O) interface 160 coupled via a bus 100. As above, the videoconferencing endpoint 10 has the base microphone 120, loudspeaker 130, the camera 46, and the display 48.

The processing unit 110 includes a CPU, a GPU, or both. The memory 140 can be any conventional memory such as SDRAM and can store modules 145 in the form of software and firmware for controlling the videoconferencing endpoint 10. The stored modules 145 include the various video and audio codecs 32/42 and software components of the other modules 20/30/40/50/200 discussed previously. Moreover, the modules 145 can include operating systems, a graphical user interface (GUI) that enables users to control the videoconferencing endpoint 10, and other algorithms for processing audio/video signals.

The network interface 150 provides communications between the videoconferencing endpoint 10 and remote videoconferencing endpoints (60). By contrast, the general I/O interface 160 can provide data transmission with local devices such as a keyboard, mouse, printer, overhead projector, display 48, external loudspeakers, additional cameras 46, microphones, etc.

As described above, the videoconferencing endpoint 10 captures frames (705) of video, selectively crops the frames (705) to view regions, and selectively applies deformation (507) or distortion-correction (508) to the view regions based on size of the view regions. Because distortion (405) may be more noticeable in relatively larger view regions and deformation (507) may be more noticeable in relatively smaller view regions, selectively using one of the correction techniques enhances quality of video during a communication session by addressing irregularities that may be more noticeable to a communication session participant. Thus, FIG. 2 illustrates an example physical configuration of a device that selectively corrects deformation (507) or distortion (405) to enhance quality of a video.

In many artificial intelligence-based cameras 46, when an active speaker is determined an active speaker view is formed by cropping the region containing the speaker's face (308) from a full view captured by the camera 46. When someone at the far end looks at the feed containing the wide view and the feed containing the active talker, he or she will tend to notice (and be distracted by) distortion (405) in the wide view, while he or she will tend to notice (and be distracted and/or disturbed by) any deformation (507) of the face (308) if present. In a full view, the viewer would care more about the geometric reality of background since it occupies the most regions in an image. In active speaker view, the viewer cares more about proper depiction of the single person who is the subject of the active speaker view. If the lens distortion-correction (508) formula that is used for a full view is also used in a corresponding active speaker view, the deformation (507) of the facial features can be made more noticeable. In at least one example of this disclosure, systems and methods (800) are described which address this problem.

In at least one example of this disclosure, in the central region (301) of a full view image, distortion (405) and deformation (507) could be corrected very well at the same time. But in corner regions, deformation (507) of a human face (308) will increase if the corrective measures applied to the central region (301) are applied in the same way to the corner regions.

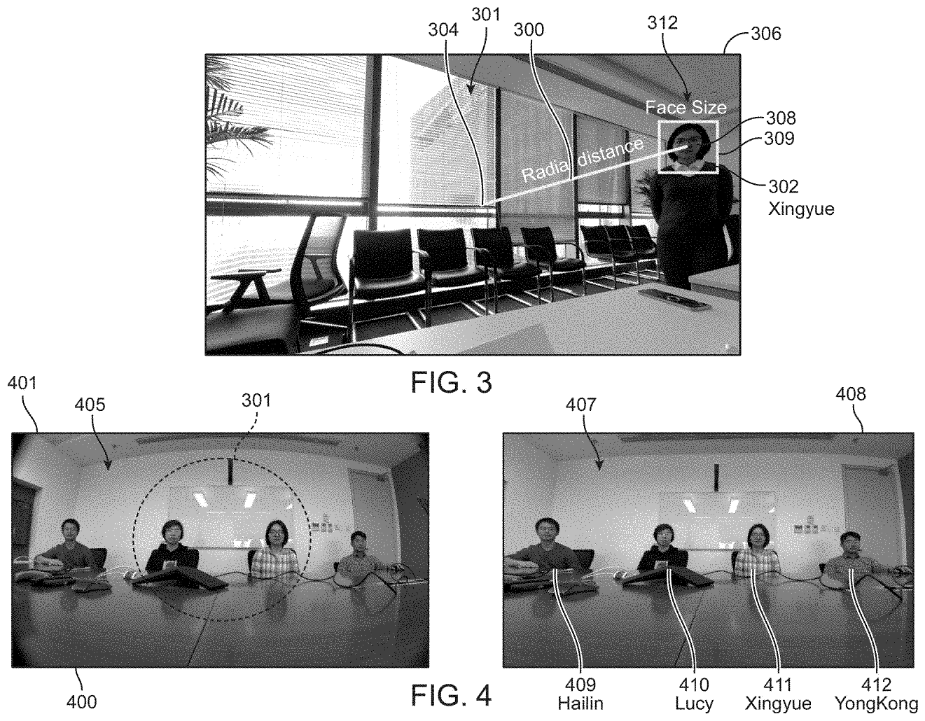

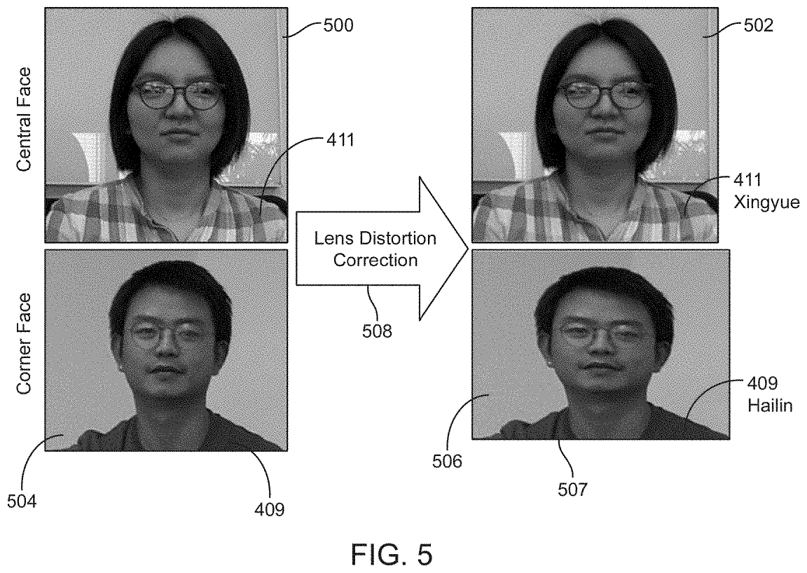

FIG. 3 illustrates an image 306, which has been corrected (508) for distortion (405). Correction (508) for distortion (405) is evidenced by the fact that the lines of the furniture and windows are straight. Within the room view (401) depicted in the image 306, we see Xingyue, who is the subject 302 of the image 306. Xingyue's face 308 is depicted within a portion 309 of the image 306. The portion 309 of the image 306 depicting Xingyue's face 308 has a center 312. The depiction of Xingyue's face 308 shows some deformation (507). Image deformation (507) of a subject 302 increases as the distance 300 of the subject 302 from the center 304 of the image 306 increases. Image deformation (507) of a subject 302 increases as the distance 300 of the center 312 of the portion 309 of the image 306 containing the subject 302 from the center 304 of the image 306 increases. In at least one example of this disclosure, the selection of a lens distortion-correction (508) formula will be based, at least in part, on the distance 300 of the face 308 to be included in an active talker view from the center 304 of the image 306. The center 304 of the image 306 defines and falls within the central region 301 of the image 306. In at least one example of this disclosure, for a magnified face 308 a correction method which relies more heavily on deformation-reduction (1050) than would be desirable can be used. In at least one example of this disclosure, for faces which are farther from the camera 46—and thus smaller—a correction method which is weighted less heavily toward deformation-reduction (1050) is used, thereby balancing the quality of the depiction of the face 308 and surrounding background. Due to the nature of lenses and the way light travels, there is always a tradeoff between distortion-correction (508) and deformation-reduction (1050). These principles are illustrated in FIG. 4 and FIG. 5. FIG. 4 shows a room view 401 image 400 captured with a wide-angle camera 46 and a corrected version 403 in which the distortion 405 of the room view 401 image 400 has been reduced 407. The features of the subjects 409 which are farther from the center (304) of the image 400, 403, are however, noticeably more deformed that the subjects 411 close to the center 304).

FIG. 5 shows a pre-distortion-correction speaker view 500 of near-center participant 411 and a speaker view 502 of the near-center participant 411 after distortion-correction has been implemented. FIG. 5 also shows a pre-distortion-correction speaker view 504 of distant-from-center participant 409 and a speaker view 506 of the distant-from-center participant 409 after distortion-correction has been implemented. FIG. 5 thus illustrates that distortion-correction in regions closer to the center 304 of the image 403 can, if left unchecked, cause greater deforming effects (deformation) 507 if applied to more eccentric regions of the image 403).

In at least one example of this disclosure, for most wide-angle lenses, the faces in central area of the view captured by a wide-angle lens are noticeably visually pleasing after lens distortion-correction 508. As demonstrated in FIG. 4 and FIG. 5, Xingyue's appearance 500, 502 is not noticeably altered by lens distortion-correction 508. Indeed, when comparing a centrally located face 410, 411 to a more peripherally located face 409, 412 there is virtually no visible distortion, whereas an image 504 of a face 409 that is located towards the outer edge of the image 400 will be more noticeably deformed 506.

In at least one example of this disclosure, the radius 300 of the central portion of a view 400 captured by a wide-angle camera 46 for which lens distortion-correction 508 does not cause noticeable deformation 507 of faces is approximately 700 pixels. In at least one example of this disclosure, the “minimal-deformation” zone of a lens with a wider angle of view will have a radius that is smaller than 700 pixels.

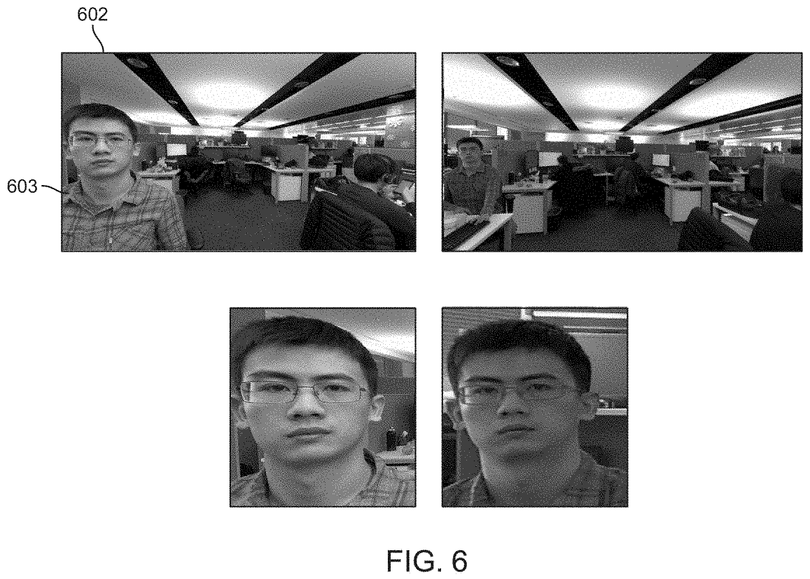

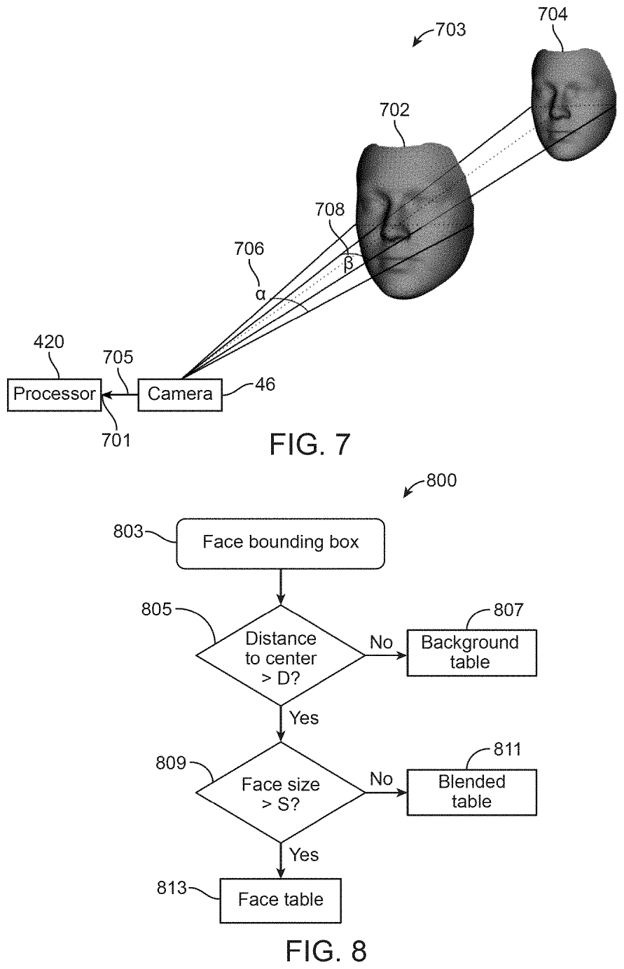

Whether a facial image is located in the minimal-deformation zone is thus a major determiner for whether distortion-correction 508 will induce deformation 507, such as occurred for Hailin in FIG. 5. Another major determiner is the distance of the image's 400 subject from the camera 46. This principle is illustrated in FIG. 6. In FIG. 6, image 602 and image 604 have both undergone lens distortion-correction 508. In image 602, Tianran 603 is about 0.5 meters from the camera 46. In image 604, Tianran 603 is about 2.0 meters from the camera 46. In image 606, Tianran 603 from image 602 is magnified in a zoom (active talker) view. In image 608, Tianran 603 from image 604 is magnified. When Tianran 603 is sitting closer to the camera 46 (e.g., 602, 606), lens distortion-correction 508 causes more deformation 507 than when Tianran 603 sits farther away (e.g., 604, 608). The cause of this is illustrated in FIG. 7.

FIG. 7 illustrates a processor 1220 (110) receiving 701 frames 705 of facial data 703 captured by a camera 46. As illustrated in FIG. 7, from the perspective of the camera 46, the field of view 706 of a face 702 which is close to the camera 46 is larger than the field of view 708 corresponding to a face 704 which is farther away from the camera 46. Thus, face size in an image 306, 400 is a proxy datum for the distance of the subject from the viewing camera 46. For any given raw video feed, faces of persons who are closer to the camera will appear larger than those who are farther away. The larger a face 308 in a captured image 306, 400, the greater the noticeable deformation 507 of that face 308 (all else being equal) in an image 403 which has been corrected 508 for lens distortion 405 in the captured image 400. Thus, when Tianran 603 sat at about 0.5 meters from the camera, lens distortion-correction 508 caused significant deformation 507 (see 606). Conversely, when Tianran 603 sat about 2.0 meters away from the camera 46, deformation 507 was much less noticeable (see 608). In the zoom view of Tianran 603 at 0.5 meters, it will be appropriate to make correct substantially for deformation 507, even if some of the effects of the initial distortion-correction are negated—the viewer will place greater importance on the proportionality of Tianran's face than on warping of straight lines which might be noticeable in the background. Conversely, when Tianran 603 is farther away from the camera 46 range, less deformation 507 reduction/adjustment will be required than for when he was closer (e.g., 606) and therefore correction for distortion 405 can still be strongly implemented.

In at least one example of this disclosure, a lens distortion 405 correction formula will be determined based on a face's location 308 in an image 400, 306 with respect to the center 304 (e.g., the distance 300 of the face 308 from the center 304), and the distance 300 of the face 308 from the camera 46. As noted, both the distance 300 of the face 308 from the center 304 and the distance 300 of the face 308 from the camera 46 cause variations in deformations 507 of the face 308 in question. At least one example of this disclosure includes a computationally efficient way of balancing the need for distortion-correction with the need for deformation 507 reduction/minimization (1050). At least one example of this disclosure includes a method of switching among three different lens distortion-correction tables based on the distance 300 of the face 308 from the center 304 and the distance of the face 300 from the camera 46.

FIG. 8 illustrates a method 800 of adaptively correcting for (1050) facial image deformation 507. According to the method 800, first, a videoconferencing endpoint 10 will detect an active speaker (e.g., 411) and create 803 an active speaker view (e.g., 500) for that person 411. The method 800 then determines 803 whether the face's 308 distance 300 from the center 304 of the room view 401 image 306, 400 exceeds a threshold (D) determined by factors including the field of view of the camera 46 capturing the room view 401 (306, 400). If the face's 308 distance 300 from the center 304 of the room view 401 image 306, 400 does not exceed the threshold—meaning the face 308 is closer to the center 304—a first “background” look-up table is used. The background look-up table emphasizes distortion-correction 508. Weighting towards distortion-correction 508 is acceptable because, as noted, distortion-correction 508 does not cause very much deformation 507 to the central regions 301 of an image 306. If, however, the face's 308 distance 300 from the center 304 of the room view 401 image 306, 400 exceeds the threshold (D), the method 800 makes a determination 809 of the subject's 302 distance from the camera 46 using the size 308 of the subject's 302 face as a proximity for the subject's 302 distance from the camera 46. If the face 308 has a size which exceeds a size threshold (S), then a “large face” lookup table is used 813. If the face 308 has a size which does not exceed the size threshold (S), then a third “mild” lookup table is used 811. The large face lookup table 813 puts greater emphasis on deformation 507 reduction (1050) than do the background table 807 and the mild table 811. The mild table 811 balances deformation 507 reduction (1050) and distortion-correction 508 more evenly than the background table 807 and the large face table 813.

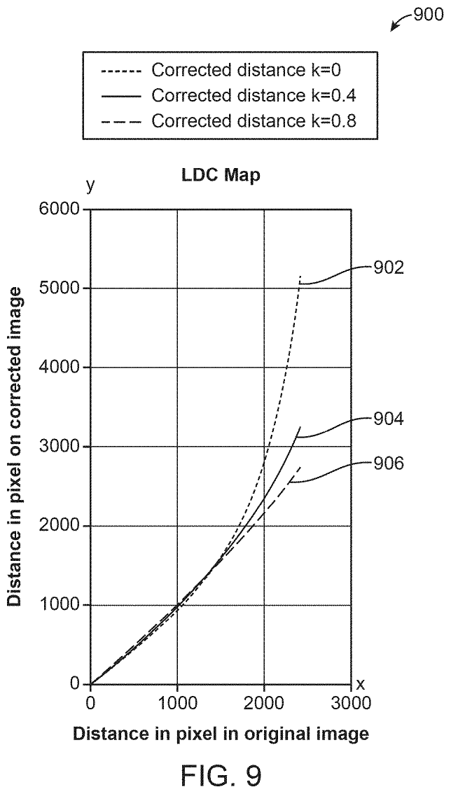

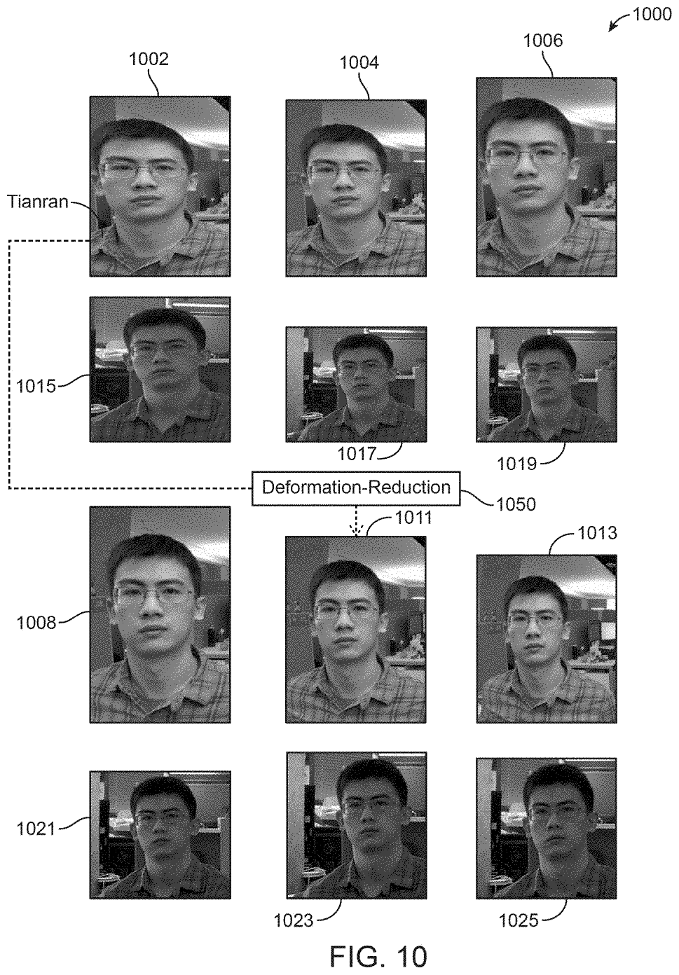

Values of an example background lookup table 807 are shown below in Table 1. Values of an example blended lookup table 811 are shown below in table 3. Values of an example large face lookup table 813 in Table 3. Some values from the tables 807, 811, and 813 are plotted in the lens distortion-correction 508 with deformation-reduction (1050) map 900 of FIG. 9. In the map 900, the distance of a given pixel from the center of the original image 400 is shown on the x-axis, and the corresponding position of that pixel after adjustment is shown on the y-axis. In the map 900, curve 902 corresponds to lens distortion-correction 508 with deformation-reduction (1050) for a depiction of face 308 that is located primarily in the central portion 301 of a wide-view image 400. In the map 900, curve 904 corresponds to lens distortion-correction 508 with deformation-reduction (1050) for a smaller depiction of a face 308 that is located primarily outside of the central portion 301 of a wide-view image 400. In the map 900, curve 906 corresponds to lens distortion-correction 508 with deformation-reduction (1050) for a larger depiction of a face 308 that is located primarily outside of the central portion 301 of a wide-view image 400.

TABLE 1
Centrally Located Face

| | Centrally Located Face |
|---|---|
| | (807) |
| Original distance | Corrected distance k = 0 |
| 0 | 0 |
| 132.3514883 | 111.1386225 |
| 264.7467153 | 223.6477128 |
| 397.6244106 | 338.9661805 |
| 531.1598401 | 458.6772124 |
| 665.5051737 | 584.6002982 |
| 801.2896183 | 718.9114698 |
| 938.9000808 | 864.3098463 |
| 1340.096363 | 1371.710202 |
| 1486.687442 | 1604.174689 |
| 1636.657006 | 1881.751633 |
| 1790.35173 | 2223.595492 |
| 1921.329875 | 2579.534435 |
| 2081.992138 | 3136.810866 |
| 2245.741321 | 3927.163589 |
| 2411.481481 | 5154.381073 |

TABLE 2
Small Face Outside Central Region

| | Peripherally Located |
|---|---|
| | Small Face (811) |
| | Corrected distance |
| Original distance | k = 0.4 |
| 0 | 0 |
| 132.3514883 | 125.5252476 |
| 264.7467153 | 251.9315515 |
| 397.6244106 | 380.1266529 |
| 531.1598401 | 511.0734355 |
| 665.5051737 | 645.8221301 |
| 801.2896183 | 785.5486944 |
| 938.9000808 | 931.6025698 |
| 1340.096363 | 1394.991071 |
| 1486.687442 | 1583.230021 |
| 1636.657006 | 1789.566205 |
| 1790.35173 | 2018.652006 |
| 1921.329875 | 2231.349615 |
| 2081.992138 | 2519.882037 |
| 2245.741321 | 2855.550411 |
| 2411.481481 | 3254.780475 |

TABLE 3
Small Face Outside Central Region

| | Peripherally Located |
|---|---|
| | Large Face (811) |
| Original distance | Corrected distance k = 0.8 |
| 0 | 0 |
| 132.3514883 | 131.7375954 |
| 264.7467153 | 264.0131833 |
| 397.6244106 | 397.3743244 |
| 531.1598401 | 532.3880977 |
| 665.5051737 | 669.6518409 |
| 801.2896183 | 809.8051477 |
| 938.9000808 | 953.5436805 |
| 1340.096363 | 1387.378261 |
| 1486.687442 | 1552.883502 |
| 1636.657006 | 1726.779781 |
| 1790.35173 | 1910.57081 |
| 1921.329875 | 2072.573237 |
| 2081.992138 | 2279.437149 |
| 2245.741321 | 2502.34689 |
| 2411.481481 | 2744.503718 |

FIG. 10 illustrates a plurality 1000 of focus-view images. In focus-view images 1002, 1004, 1006, 1008, 1010, 1013, the manner in which Tianran 603 was depicted in image 602 (in which Tianran is 0.5 meters from the camera 46) is modified, with image 1002 illustrating the least amount of deformation-reduction 1050 and image 1013 illustrating the greatest amount of deformation-reduction 1050. In focus-view images 1015, 1017, 1019, 1021, 1023, and 1025, the manner in which Tianran 603 is depicted in image 604 (in which Tianran is two meters from the camera 46) is modified, with image 1015 illustrating the least amount of deformation-reduction 1050 and image 1025 illustrating the greatest amount of deformation-reduction 1050. Of the images showing Tianran at 0.5 meters (1002, 1004, 1006, 1008, 1010, 1013), image 1010 is the most natural. Of the images showing Tianran at two meters (1015, 1017, 1019, 1021, 1023, 1025), image 1019 is the most natural. The images 1000 of FIG. 10 demonstrate that when the subject is closer (e.g., 602) to (and off center of) a wide-angle camera 46, lens distortion-correction has a greater tendency to cause image deformation than when the subject is farther away from the camera 46 (e.g., 604).

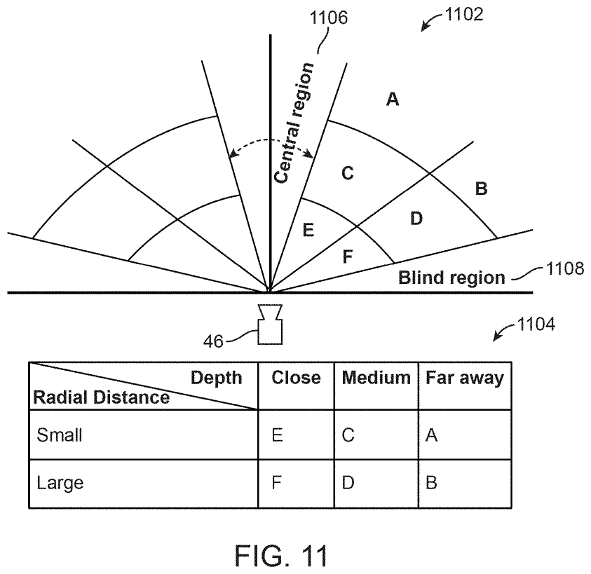

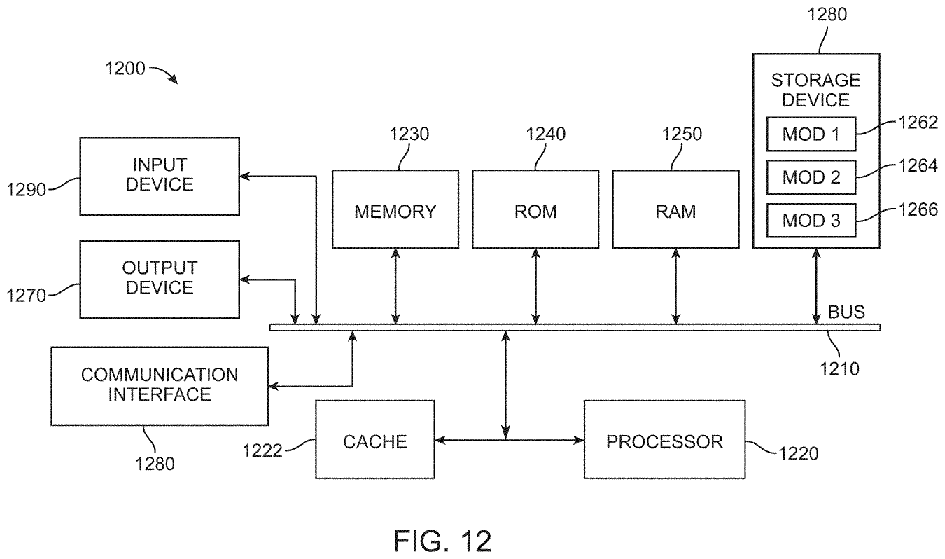

FIG. 11 illustrates a field of view 1102 for a wide-angle camera 46 with a 160-degree lens, in accordance with an example of this disclosure. The blind regions 1108 define the limits of the camera's field of view 1102. The camera's 46 field of view 1102 has a central region 1106 (e.g., 301). The field of view 1102 can be subdivided into zones (A, B, C, D, E, F) according to distance from the camera 46 and angular distance away from the central region 1106. Each of the zones (A, B, C, D, E, F) can have its own lookup table as organized in chart 1104.

FIG. 12 illustrates an electronic device 1200 (such as videoconferencing endpoint 10) which can be employed to practice the concepts and methods 800 described above. The components disclosed herein can be incorporated in whole or in part into tablet computers, personal computers, handsets and other devices utilizing one or more microphones. As shown, device 1200 can include a processor (CPU or processor) 1220 (110) and a system bus 1210. System bus 1210 interconnects various system components—including the system memory 1230 such as read only memory (ROM) 1240 and random-access memory (RAM) 1250—to the processor 1220 (110). The processor 1220 (110) can be a DSP (e.g., 1233, 1235, see FIG. 12) The device 1200 can include a cache 1222 of high-speed memory connected directly with, near, or integrated as part of the processor 1220 (110). The device 1200 copies data from the memory 1230 and/or the storage device 1260 to the cache 1222 for quick access by the processor 1220 (110). In this way, the cache provides a performance boost that avoids processor 1220 (110) delays while waiting for data. These and other modules can control or be configured to control the processor 1220 (110) to perform various actions. Other system memory 1230 may be available for use as well. The memory 1230 can include multiple different types of memory with different performance characteristics. The processor 1220 (110) can include any general-purpose processor and a hardware module or software module, such as module 1 (1262), module 2 (1264), and module 3 (1266) stored in storage device 1260, configured to control the processor 1220 (110) as well as a special-purpose processor where software instructions are incorporated into the actual processor 1220 (110) design. The processor 1220 (110) may essentially be a completely self-contained computing system, containing multiple cores or processors, a bus, memory controller, cache, etc. A multi-core processor 1220 (110) may be symmetric or asymmetric.

The system bus 1210 may be any of several types of bus structures including a memory bus or memory controller, a peripheral bus, and a local bus using any of a variety of bus architectures. A basic input/output system (BIOS) stored in ROM 1240 or the like, may provide the basic routine that helps to transfer information between elements within the device 1200, such as during start-up. The device 1200 further includes storage devices 1260 such as a hard disk drive, a magnetic disk drive, an optical disk drive, tape drive or the like. The storage device 1260 can include software modules 1262, 1264, 1266 for controlling the processor 1220 (110). Other hardware or software modules are contemplated. The storage device 1260 is connected to the system bus 1210 by a drive interface. The drives and the associated computer readable storage media provide nonvolatile storage of computer readable instructions, data structures, program modules and other data for the device 1200. In at least one example, a hardware module that performs a function includes the software component stored in a non-transitory computer-readable medium coupled to the hardware components—such as the processor 1220 (110), bus 1210, output device 1270, and so forth—necessary to carry out the function.

For clarity of explanation, the device of FIG. 12 is presented as including individual functional blocks including functional blocks labeled as a “processor” or processor 1220 (110). The functions these blocks represent may be provided using either shared or dedicated hardware, including, but not limited to, hardware capable of executing software and hardware, such as a processor 1220, that is purpose-built to operate as an equivalent to software executing on a general-purpose processor. For example, the functions of one or more processors presented in FIG. 12 may be provided by a single shared processor or multiple processors. (Use of the term “processor” should not be construed to refer exclusively to hardware capable of executing software.) One or more examples of this disclosure include microprocessor hardware, and/or digital signal processor (DSP) hardware, read-only memory (ROM) 1240 for storing software performing the operations discussed in one or more examples below, and random-access memory (RAM) 1250 for storing results. Very large-scale integration (VLSI) hardware components, as well as custom VLSI circuitry in combination with a general-purpose DSP circuit (1233, 1235), can also be used.

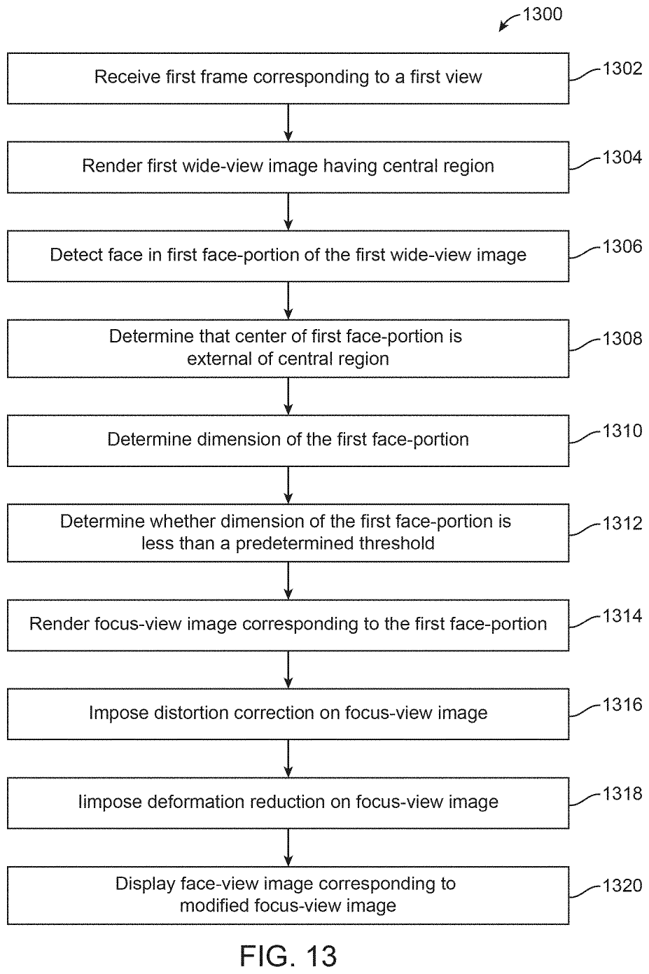

FIG. 13 illustrates a method 1300 of reducing deviations in images captured by a wide-view camera. The method 1300 includes: receiving 1302 a first frame corresponding to a first view; rendering 1304 a first wide-view image having central region; detecting 1306 data indicative of a face in first face-portion 309 of the first wide-view image; determining 1308 that the center of first face-portion 309 is external of the central region of the first wide-view image; determining 1310 a dimension (e.g., width of 300 pixels, width of 400 pixels) of the first face-portion; determining 1312 whether the dimension of the first face-portion 309 is less than a predetermined threshold (e.g., width of 250 pixels); rendering 1314 a focus-view image 1011, 1019 corresponding to the first face-portion; imposing 1316 some amount of distortion-correction on the focus-view image 1011, 1019; imposing 1318 some amount of deformation-reduction 1050 on the focus-view image 1011, 1019; and displaying 1320 a face-view image corresponding to modified focus-view image 1011, 1019.

Examples of this disclosure include:

Example 1. A method 800, 1300 for reducing deviations in images 400 captured by a wide-angle camera 46, comprising: receiving 701, at a processor 110, 1220, a first frame 705 corresponding to a first view 401; rendering, using the processor 110, 1220, a first wide-view image 403 corresponding to the first frame 705, the first wide-view image 403 having a central region 301; detecting, using the processor 110, 1220, a face 308 in a first face-portion 309 of the first wide-view image 403, the first face-portion 309 having a center 312; determining 1308, using the processor 110, 1220, that the center 312 of the first face-portion 309 is external of the central region 301 of the first wide-view image 403; determining 1310, using the processor 110, 1220 and based on the determination 1308 that the center 312 of the first face-portion 309 is external of the central region 301 of the first wide-view image 403, a dimension of the first face-portion; determining 1312, using the processor 110, 1220, that the dimension of the first face-portion 309 is less than a predetermined threshold (e.g., 250 pixels); and rendering 1314, using the processor 110, 1220, a first focus-view image 1011, 1019 corresponding to the first face-portion 309, wherein rendering 1314 the first focus-view image 1011, 1019 includes imposing a degree of distortion-correction 508 on the first face-portion 309 and imposing a degree of deformation-reduction 1050 on the first face-portion 309.

Example 2. The method 800, 1300 of example 1, further comprising: receiving 701, at the processor 110, 1220, a second frame 705 corresponding to a second view; rendering, using the processor 110, 1220, a second wide-view image 403 corresponding to the second frame 705, the second wide-view image 403 having a central region 301; detecting, using the processor 110, 1220, a second face 308 in a second face-portion 309 of the second wide-view image 403, the second face-portion 309 having a center; determining, using the processor 110, 1220, that the center 312 of the second face-portion 309 is external of the central region 301 of the second wide-view image 403; determining, using the processor 110, 1220 and based on the determination that the center 312 of the second face-portion 309 is external of the central region 301 of the second wide-view image 403, a dimension of the second face-portion; determining, using the processor 110, 1220, that the dimension of the second face-portion 309 is greater than or equal to the predetermined threshold; and rendering 1314, using the processor 110, 1220, a second focus-view image 1011, 1019 corresponding to the second face-portion, wherein rendering 1314 the second focus-view image 1011, 1019 includes imposing a degree of distortion-correction 508 on the second face-portion 309 and imposing a degree of deformation-reduction 1050 on the second face-portion, wherein the degree of distortion-correction 508 imposed on the second face-portion 309 is lower than the degree of distortion-correction 508 imposed on the first face-portion, and wherein the degree of deformation-reduction 1050 imposed on the second face-portion 309 is greater than the degree of deformation-reduction 1050 imposed on the first face-portion 309.

Example 3. The method 800, 1300 of example 2, further comprising: receiving 701, at the processor 110, 1220, a third frame 705 corresponding to a third view; rendering, using the processor 110, 1220, a third wide-view image 403 corresponding to the third frame 705, the third wide-view image 403 having a central region 301; detecting, using the processor 110, 1220, a third face 308 in a third face-portion 309 of the third wide-view image 403, the third face-portion 309 having a center; determining, using the processor 110, 1220, that the center 312 of the third face-portion 309 is internal to the central region 301 of the third wide-view image 403; rendering 1314, using the processor 110, 1220 and based on the determination that the center 312 of the third face-portion 309 is external of the central region 301 of the third wide-view image 403, a third focus-view image 1011, 1019 corresponding to the third face-portion, wherein rendering 1314 the third focus-view image 1011, 1019 includes imposing a degree of distortion-correction 508 on the third face-portion 309 and imposing a degree of deformation-reduction 1050 on the third face-portion, wherein the degree of distortion-correction 508 imposed on the third face-portion 309 is greater than the degree of distortion-correction 508 imposed on the first face-portion, and wherein the degree of deformation-reduction 1050 imposed on the third face-portion 309 is lower than the degree of deformation-reduction 1050 imposed on the first face-portion.

Example 4. The method 800, 1300 of example 3, wherein the first frame 705, the second frame 705, and the third frame 705 are the same, and wherein the first wide-view image 403, the second wide-view image 403, and the third wide-view image 403 are different.

Example 5. The method 800, 1300 of example 3, wherein: imposing the degree of distortion-correction 508 to the first face-portion 309 and imposing the degree of deformation-reduction 1050 to the first face-portion 309 comprise fetching values from a first lookup table; imposing the degree of distortion-correction 508 on the second face-portion 309 and imposing the degree of deformation-reduction 1050 on the second face-portion 309 comprise fetching values from a second lookup table; imposing the degree of distortion-correction 508 on the third face-portion 309 and imposing the degree of deformation-reduction 1050 on the third face-portion 309 comprise fetching values from a third lookup table, and wherein some values in the first lookup table are based on extrapolation of some values in the third lookup table and some values in the first lookup table are based on interpolation of some values in the second lookup table.

Example 6. The method 800, 1300 of example 1, wherein the central region 301 of the first wide-view image 403 has a radius of 700 pixels centered in the first wide-view image 403.

Example 7. The method 800, 1300 of example 1, wherein the dimension of the first face-portion 309 is a width and the predetermined threshold is 250 pixels.

Example 8. The method 800, 1300 of example 1, further comprising capturing image data corresponding to the first frame 705 using a wide-angle lens.

Example 9. The method 800, 1300 of example 1, wherein capturing image data corresponding to the first frame 705 using an image sensor with a field of view greater than one hundred and fifty-nine degrees, and less than one hundred and eighty degrees.

Example 10. The method 800, 1300 of example 1, wherein rendering the first wide-view image 403 comprises displaying the first wide-view image 403 using a first display device 48, and wherein rendering 1314 the first focus-view image 1011, 1019 comprises displaying at least some of the first focus-view image 1011, 1019 using a second display device 1270.

Example 11. The method 800, 1300 of example 10, wherein the first display device 48 and the second display device 1270 are different.

Example 12. A videoconferencing endpoint 10, comprising: a wide-angle camera 46; a display device 48; a processor 110, 1220 coupled to the wide-angle camera 46 and the display device 48; a memory storing instructions executable by the processor 110, 1220, wherein the instructions comprise instructions to: receive a first frame 705 corresponding to a first view 401; render a first wide-view image 403, the first wide-view image 403 corresponding to the first frame 705 and having a central region 301; detect a face 308 in a first face-portion 309 of the first wide-view image 403, the first face-portion 309 having a center; determine that the center 312 of the first face-portion 309 is external of the central region 301 of the first wide-view image 403; determine, using the processor 110, 1220 and based on the determination that the center 312 of the first face-portion 309 is external of the central region 301 of the first wide-view image 403, a dimension of the first face-portion; determine that the dimension of the first face-portion 309 is less than a predetermined threshold; render, using the display device 48, a focus-view image 1011, 1019 corresponding to the first face-portion, wherein the instructions to render, using the display device 48, the focus-view image 1011, 1019 include instructions to impose a degree of distortion-correction 508 to the first face-portion 309 and impose a degree of deformation-reduction 1050 to the first face-portion.

Example 13. The videoconferencing endpoint 10 of example 12, wherein the instructions further comprise instructions to: receive a second frame 705 corresponding to a second view; render, using the display device 48, a second wide-view image 403 corresponding to the second frame 705, the second wide-view image 403 having a central region 301; detect a second face 308 in a second face-portion 309 of the second wide-view image 403, the second face-portion 309 having a center; determine that the center 312 of the second face-portion 309 is external of the central region 301 of the second wide-view image 403; determine, using the processor 110, 1220 and based on the determination that the center 312 of the second face-portion 309 is external of the central region 301 of the second wide-view image 403, a dimension of the second face-portion; determine that the dimension of the second face-portion 309 is greater than or equal to the predetermined threshold; render, using the display device 48, a second focus-view image 1011, 1019 corresponding to the second face-portion, wherein the instructions to render the second focus-view image 1011, 1019 include instructions to impose a degree of distortion-correction 508 on the second face-portion 309 and impose a degree of deformation-reduction 1050 on the second face-portion 309, whereby the degree of distortion-correction 508 imposed on the second face-portion 309 is lower than the degree of distortion-correction 508 imposed on the first face-portion, and whereby the degree of deformation-reduction 1050 imposed on the second face-portion 309 is greater than the degree of deformation-reduction 1050 imposed on the first face-portion.

Example 14. The videoconferencing endpoint 10 of example 13, the instructions further comprising instructions to: receive a third frame 705 corresponding to a third view; render, using the display device 48, a third wide-view image 403 corresponding to the third frame 705, the third wide-view image 403 having a central region 301; detect a third face 308 in a third face-portion 309 of the third wide-view image 403, the third face-portion 309 having a center; determine that the center 312 of the third face-portion 309 is internal to the central region 301 of the third wide-view image 403; render, using the display device 48 and based on the determination that the center 312 of the third face-portion 309 is external of the central region 301 of the third wide-view image 403, a third focus-view image 1011, 1019 corresponding to the third face-portion, wherein the instructions to render the third focus-view image 1011, 1019 include instructions to impose a degree of distortion-correction 508 on the third face-portion 309 and impose a degree of deformation-reduction 1050 on the third face-portion, whereby the degree of distortion-correction 508 imposed on the third face-portion 309 is greater than the degree of distortion-correction 508 imposed on the first face-portion, and whereby the degree of deformation-reduction 1050 imposed on the third face-portion 309 is lower than the degree of deformation-reduction 1050 imposed on the first face-portion.

Example 15. The videoconferencing endpoint 10 of example 14, wherein the first frame 705, the second frame 705, and the third frame 705 are the same, and wherein the first wide-view image 403, the second wide-view image 403, and the third wide-view image 403 are different.

Example 16. The videoconferencing endpoint 10 of example 14, wherein: the instructions to impose the degree of distortion-correction 508 to the first face-portion 309 and impose the degree of deformation-reduction 1050 to the first face-portion 309 comprise instructions to fetch values from a first lookup table; the instructions to impose the degree of distortion-correction 508 on the second face-portion 309 and impose the degree of deformation-reduction 1050 on the second face-portion 309 comprise instructions to fetch values from a second lookup table; the instructions to impose the degree of distortion-correction 508 on the third face-portion 309 and impose the degree of deformation-reduction 1050 on the third face-portion 309 comprise instructions to fetch values from a third lookup table, wherein the first lookup table, the second lookup table, and the third lookup table are different.

Example 17. The videoconferencing endpoint 10 of example 12, wherein the central region 301 of the first wide-view image 403 has a radius of 700 pixels centered in the first wide-view image 403.

Example 18. The videoconferencing endpoint 10 of example 12, wherein the dimension of the first face-portion 309 is a width and the predetermined threshold is fifteen percent of the width of the wide-view image 403.

Example 19. The videoconferencing endpoint 10 of example 12, wherein the wide-angle camera 46 comprises a wide-angle lens.

Example 20. The videoconferencing endpoint 10 of example 12, wherein the wide-angle camera 46 comprises an image sensor with a field of view greater than one hundred and fifty-nine degrees, and less than one hundred and eighty degrees.

The examples described above are provided by way of illustration only and should not be construed to limit the scope of the disclosure. Various modifications and changes can be made to the principles and examples described herein without departing from the scope of the disclosure and without departing from the claims which follow.

1. A method for reducing deviations in images captured by a wide-angle camera, comprising:
receiving, at a processor, a first frame corresponding to a first view;
rendering, using the processor, a first wide-view image corresponding to the first frame, the first wide-view image having a central region;
detecting, using the processor, a face in a first face-portion of the first wide-view image, the first face-portion having a center;
determining, using the processor, that the center of the first face-portion is external of the central region of the first wide-view image;
determining, using the processor and based on the determination that the center of the first face-portion is external of the central region of the first wide-view image, a dimension of the first face-portion;
determining, using the processor, that the dimension of the first face-portion is less than a predetermined threshold; and
rendering, using the processor, a first focus-view image corresponding to the first face-portion, wherein rendering the first focus-view image includes imposing a degree of distortion-correction on the first face-portion and imposing a degree of deformation-reduction on the first face-portion.

2. The method of claim 1, further comprising:
receiving, at the processor, a second frame corresponding to a second view;
rendering, using the processor, a second wide-view image corresponding to the second frame, the second wide-view image having a central region;
detecting, using the processor, a second face in a second face-portion of the second wide-view image, the second face-portion having a center;
determining, using the processor, that the center of the second face-portion is external of the central region of the second wide-view image;
determining, using the processor and based on the determination that the center of the second face-portion is external of the central region of the second wide-view image, a dimension of the second face-portion;
determining, using the processor, that the dimension of the second face-portion is greater than or equal to the predetermined threshold;
rendering, using the processor, a second focus-view image corresponding to the second face-portion, wherein rendering the second focus-view image includes imposing a degree of distortion-correction on the second face-portion and imposing a degree of deformation-reduction on the second face-portion,
wherein the degree of distortion-correction imposed on the second face-portion is lower than the degree of distortion-correction imposed on the first face-portion, and wherein the degree of deformation-reduction imposed on the second face-portion is greater than the degree of deformation-reduction imposed on the first face-portion.

3. The method of claim 2, further comprising:
receiving, at the processor, a third frame corresponding to a third view;
rendering, using the processor, a third wide-view image corresponding to the third frame, the third wide-view image having a central region;
detecting, using the processor, a third face in a third face-portion of the third wide-view image, the third face-portion having a center;
determining, using the processor, that the center of the third face-portion is internal to the central region of the third wide-view image;
rendering, using the processor and based on the determination that the center of the third face-portion is external of the central region of the third wide-view image, a third focus-view image corresponding to the third face-portion, wherein rendering the third focus-view image includes imposing a degree of distortion-correction on the third face-portion and imposing a degree of deformation-reduction on the third face-portion,
wherein the degree of distortion-correction imposed on the third face-portion is greater than the degree of distortion-correction imposed on the first face-portion, and wherein the degree of deformation-reduction imposed on the third face-portion is lower than the degree of deformation-reduction imposed on the first face-portion.

4. The method of claim 3, wherein the first frame, the second frame, and the third frame are the same, and wherein the first wide-view image, the second wide-view image, and the third wide-view image are different.

5. The method of claim 3, wherein:
imposing the degree of distortion-correction to the first face-portion and imposing the degree of deformation-reduction to the first face-portion comprise fetching values from a first lookup table;
imposing the degree of distortion-correction on the second face-portion and imposing the degree of deformation-reduction on the second face-portion comprise fetching values from a second lookup table;
imposing the degree of distortion-correction on the third face-portion and imposing the degree of deformation-reduction on the third face-portion comprise fetching values from a third lookup table, and
wherein some values in the first lookup table are based on extrapolation of some values in the third lookup table and some values in the first lookup table are based on interpolation of some values in the second lookup table.

6. The method of claim 1, wherein the central region of the first wide-view image has a radius of 700 pixels centered in the first wide-view image.

7. The method of claim 1, wherein the dimension of the first face-portion is a width and the predetermined threshold is 250 pixels.

8. The method of claim 1, further comprising capturing image data corresponding to the first frame using a wide-angle lens.

9. The method of claim 1, wherein capturing image data corresponding to the first frame using an image sensor with a field of view greater than one hundred and fifty-nine degrees, and less than one hundred and eighty degrees.

10. The method of claim 1, wherein rendering the first wide-view image comprises displaying the first wide-view image using a first display device, and wherein rendering the first focus-view image comprises displaying at least some of the first focus-view image using a second display device.

11. The method of claim 10, wherein the first display device and the second display device are different.

12. A videoconferencing endpoint, comprising:
a wide-angle camera;
a display device;
a processor coupled to the wide-angle camera and the display device; a memory storing instructions executable by the processor, wherein the instructions comprise instructions to:
receive a first frame corresponding to a first view;
render a first wide-view image, the first wide-view image corresponding to the first frame and having a central region;
detect a face in a first face-portion of the first wide-view image, the first face-portion having a center;
determine that the center of the first face-portion is external of the central region of the first wide-view image;
determine, using the processor and based on the determination that the center of the first face-portion is external of the central region of the first wide-view image, a dimension of the first face-portion;
determine that the dimension of the first face-portion is less than a predetermined threshold; and
render, using the display device, a focus-view image corresponding to the first face-portion, wherein the instructions to render, using the display device, the focus-view image include instructions to impose a degree of distortion-correction to the first face-portion and impose a degree of deformation-reduction to the first face-portion.

13. The videoconferencing endpoint of claim 12, wherein the instructions further comprise instructions to:
receive a second frame corresponding to a second view;
render, using the display device, a second wide-view image corresponding to the second frame, the second wide-view image having a central region;
detect a second face in a second face-portion of the second wide-view image, the second face-portion having a center;
determine that the center of the second face-portion is external of the central region of the second wide-view image;
determine, using the processor and based on the determination that the center of the second face-portion is external of the central region of the second wide-view image, a dimension of the second face-portion;
determine that the dimension of the second face-portion is greater than or equal to the predetermined threshold; and
render, using the display device, a second focus-view image corresponding to the second face-portion, wherein the instructions to render the second focus-view image include instructions to impose a degree of distortion-correction on the second face-portion and impose a degree of deformation-reduction on the second face-portion,
whereby the degree of distortion-correction imposed on the second face-portion is lower than the degree of distortion-correction imposed on the first face-portion, and whereby the degree of deformation-reduction imposed on the second face-portion is greater than the degree of deformation-reduction imposed on the first face-portion.

14. The videoconferencing endpoint of claim 13, the instructions further comprising instructions to:
receive a third frame corresponding to a third view;
render, using the display device, a third wide-view image corresponding to the third frame, the third wide-view image having a central region;
detect a third face in a third face-portion of the third wide-view image, the third face-portion having a center;
determine that the center of the third face-portion is internal to the central region of the third wide-view image; and
render, using the display device and based on the determination that the center of the third face-portion is external of the central region of the third wide-view image, a third focus-view image corresponding to the third face-portion, wherein the instructions to render the third focus-view image include instructions to impose a degree of distortion-correction on the third face-portion and impose a degree of deformation-reduction on the third face-portion,
whereby the degree of distortion-correction imposed on the third face-portion is greater than the degree of distortion-correction imposed on the first face-portion, and whereby the degree of deformation-reduction imposed on the third face-portion is lower than the degree of deformation-reduction imposed on the first face-portion.

15. The videoconferencing endpoint of claim 14, wherein the first frame, the second frame, and the third frame are the same, and wherein the first wide-view image, the second wide-view image, and the third wide-view image are different.

16. The videoconferencing endpoint of claim 14, wherein:
the instructions to impose the degree of distortion-correction to the first face-portion and impose the degree of deformation-reduction to the first face-portion comprise instructions to fetch values from a first lookup table;
the instructions to impose the degree of distortion-correction on the second face-portion and impose the degree of deformation-reduction on the second face-portion comprise instructions to fetch values from a second lookup table; and
the instructions to impose the degree of distortion-correction on the third face-portion and impose the degree of deformation-reduction on the third face-portion comprise instructions to fetch values from a third lookup table,
wherein the first lookup table, the second lookup table, and the third lookup table are different.

17. The videoconferencing endpoint of claim 12, wherein the central region of the first wide-view image has a radius of 700 pixels centered in the first wide-view image.

18. The videoconferencing endpoint of claim 12, wherein the dimension of the first face-portion is a width and the predetermined threshold is 500 pixels.

19. The videoconferencing endpoint of claim 12, wherein the wide-angle camera comprises a wide-angle lens.

20. The videoconferencing endpoint of claim 12, wherein the wide-angle camera comprises an image sensor with a field of view greater than one hundred and fifty-nine degrees, and less than one hundred and eighty degrees.
